(19) United States
(12) Patent Application Publication
(10) Pub. No.: US 2011/0302633 A1
(43) Pub. Date: Dec. 8, 2011

(54) Safe Internet Browser

(76) Inventor: Robert J. Windschauer, Tampa, FL (US)

(21) Appl. No.: 12/981,976

(22) Filed: Dec. 30, 2010

Related U.S. Application Data
(60) Provisional application No. 61/352,085, filed on Jun. 7, 2010.

(51) Int. Cl. G06F 21/00

(52) U.S. Cl. 726/4

(57) ABSTRACT

The present invention provides a computer program product for implementing supervision functions for Internet browsing. The computer program product including a plurality of computer executable instructions stored on a computer readable medium. Wherein, the instructions when executed by a computer having a graphical user interface cause the computer to perform the steps of initiating a custom browser on the computer. The custom browser communicates with a centralized database of authorized content. The authorized content has one or more pictograms associated to the authorized content. The one or more pictograms are displayed on the graphical user interface of the computer. Authorized content is downloaded from the Internet onto the graphical user interface of the computer in response to the activation of the one or more pictograms.

### CROSS REFERENCES TO RELATED APPLICATIONS

This application claims priority from and is related to commonly owned U.S. Provisional Patent Application Ser. No. 61/352,085 filed Jun. 7, 2010, entitled: Safe Internet Browser, this Provisional Patent Application incorporated by reference herein.

### FIELD OF THE INVENTION

The present invention relates generally to the data processing field, and more particularly, relates to a method and computer program product for implementing parental supervision for Internet browsing.

### BACKGROUND OF THE INVENTION

The Internet is a major source of information and entertainment for a growing number of people. Parents, having responsibility for minor children, need to monitor and control what their children are accessing over the Internet.

Parents need better ways to monitor what their children are browsing on the Internet. Current art provides a measure of control through censoring or filtering certain sites based on a Universal Resource Locator (URL). However, current censoring software is not infallible and can allow undesirable material. Lists are never totally complete; images cannot be analyzed for content; lists go out of date because bad sites are proliferating and changing, often with the intent of outsmarting filtering programs. Available censoring programs sometimes prohibit good sites that are not wanted to be filtered.

In response to the need for some control over Internet access by children, there have been several software products which have been simplistic attempts to block certain activity. The attempt has usually been based upon central themes, i.e. blocking all files with a suffix denoting a graphic content (.BMP, .TIF, .JPG, .GIF, and etc.). One popular software product on the market uses such a scheme, the thought being that blocking all graphics will block the child from seeing pornographic materials. However, the problem is that a child in school is unable to see any graphics pertaining to anything (including safe subjects), which severely limits use of the Internet as a learning and research tool. In addition, textual material that is seen or generated by a child can be just as pornographic and harmful to the child as a picture. The elimination of graphic files is adequate to accomplish the main purpose of a blocking program, that of screening vulgar and pornographic materials. Because this scheme is so simplistic, it blocks much more legitimate material than pornographic material and does not block pornographic material effectively.

Another simplistic approach used in the commercial product, Surfwatch™, is to prevent access to sites listed in a library of prohibited sites. However, with the rapid expansion of pornographic sites, this scheme can only control access to a fraction of the accessible pornographic sites. The library is encrypted and permits no deletion or addition of sites. A subscription to regularly updated libraries is provided, but the software provider cannot know all of the sites, and in fact a study of the library for Surfwatch™ has shown that essentially only half of the known sites are included in the library. This is not unexpected, as discovering all of the sites that exist is not a simple task. The absence of certain pornographic sites would not be a serious problem if a parent, teacher, or supervisor could add sites personally as they become known, but this is not allowed by the program.

The present invention relates generally to an improvement in advanced filtering Internet access for the children and providing a software application to them to access only safe web sites without further parental advisory. There have been some attempts to provide a children safe computing and browsing environment. In some cases filtering software is provided that enables a parent to block certain web sites from access after a dedicated hardware device is installed in the network or the existing browser application (planned for adult or young adult use) was configured in the right way.

The disadvantage of these systems is that they are designed for being configured by a skilled person with the background of network configuration. Furthermore the complexity of the user interface of the typical Internet browser applications can be daunting or discouraging for young users, and the need for parents to actively participate in all network sessions tends to reduce the use of computers by young children.

A need exists for an improved method and computer program product for implementing parental supervision for Internet browsing. It is desirable to provide parents with an effective mechanism for monitoring what their children view. It is desirable to provide an improved method and computer program product which more approximates a parent looking over the shoulder of a child, such that the parent can more quickly understand what the child is viewing and more quickly and effectively work with the bad choices the child is making.

There is therefore a need in the art for improved systems and methods for allowing a child to browse the World Wide Web or a similar WAN network without supervision. In particular, there is a need for a browser system that gives a parent complete control in selecting the web sites and individual web pages that the child may access. More particularly, there is a need for a browser system that prevents a child from accessing any web site that the parent has not approved. There is a still further need for an improved browser system that places the parental or supervisory controls directly in the desktop home personal computer.

Nothing in the prior art provides the benefits attendant with the present invention. Therefore, it is an object of the present invention to provide an improvement which overcomes the inadequacies of the prior art.

Another object of the present invention is to provide a computer implemented method for safely navigating the Internet comprising the steps of: storing authorized content in an access authorization database on a centralized server; generating one or more pictograms of said authorized content on said centralized server; initiating a custom browser on a computer having a graphical user interface, said custom browser communicating over the Internet with said access authorization database on said centralized server; displaying said one or more pictograms onto said graphical user interface; activating said one or more pictograms; and downloading said authorized content from the Internet onto said graphical user interface in response to said activation of said one or more pictograms.

Yet another object of the present invention is to provide a computer implemented method for safely navigating the Internet comprising the steps of: storing authorized content in an access authorization database on a centralized server; generating one or more pictograms of said authorized content on said centralized server; initiating a custom browser on a computer having a graphical user interface, said custom browser communicating over the Internet with said access authorization database on said centralized server; displaying said one or more pictograms onto said graphical user interface; activating said one or more pictograms; downloading said authorized content from the Internet onto said graphical user interface in response to said activation of said one or more pictograms; and controlling an amount of time on the Internet.

Still yet another object of the present invention is to provide a computer program product for implementing supervision functions for Internet browsing, said computer program product including a plurality of computer executable instructions stored on a computer readable medium, wherein said instructions, when executed by a computer having a graphical user interface, cause the computer to perform the steps of: initiating a custom browser on the computer, said custom browser communicating with a centralized database of authorized content, said authorized content having one or more pictograms associated to said authorized content; displaying said one or more pictograms on said graphical user interface; and downloading said authorized content from the Internet onto said graphical user interface when said one or more pictograms are activated.

The foregoing has outlined some of the pertinent objects of the present invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

The system provides a method and a toolset for implementing a user interface that is easily usable by the children while still providing a rich network browsing environment. In addition, the interface includes an easily understandable starting screen that lists the pictograms of safe web sites that are authorized to be visited by the child without knowing their URL.

The KidSafe Portal Client computer application is implemented as a customized Internet browser that shields non-authorized web content from its user installed on a desktop or personal computer. Collection of authorized content assets named as Safe Web Islands can be managed via a centralized server computer called KidSafe Portal Server. Safe Web Islands are assembled by skilled administrative persons after thorough safety investigation in terms of suitability of content to children and web security.

The system can use multiple graphical themes for the user interface to provide variety in the look and feel of the system and to make the browser experience more engaging for the children. New graphical themes can be purchased and downloaded via the Internet from KidSafe Portal Server.

The system also provides a time control to limit the total time spent with browsing activities by a child per day. This time control function can be used by parents to limit how much time the children can spend on the Internet.

A feature of the present invention is to provide a computer implemented method for safely navigating the Internet. The method comprising the steps of storing authorized content in an access authorization database on a centralized server. Generating one or more pictograms of the authorized content stored on the centralized server. Initiating a custom browser on a computer having a graphical user interface where in the custom browser communicates over the Internet with the access authorization database on the centralized server. Displaying one or more pictograms onto the graphical user interface of the computer. Activating one or more pictograms. Downloading authorized content from the Internet onto the graphical user interface of the computer in response to the activation of one or more pictograms.

In a preferred embodiment, the authorized content can further comprise web pages, web sites, video, audio, photographs and graphic images. In addition, through a configuration management system can be provided for controlling the authorized content.

In another preferred embodiment, the one or more pictograms can be linked to a merchant. In addition, a graphical theme can be displayed on the graphical user interface and can have news content downloaded from the Internet that is specific to the graphical theme.

In another preferred embodiment, an amount of time on the Internet can be controlled through a timer. In addition, anonymous and aggregated statistics on browsing activity can be collected.

Another feature of the present invention is to provide a computer implemented method for safely navigating the Internet. The method comprising the steps of storing authorized content in an access authorization database on a centralized server. Generating one or more pictograms of the authorized content stored on the centralized server. Initiating a custom browser on a computer having a graphical user interface where in the custom browser communicates over the Internet with the access authorization database on the centralized server. Displaying one or more pictograms onto the graphical user interface of the computer. Activating one or more pictograms. Downloading authorized content from the Internet onto the graphical user interface of the computer in response to the activation of one or more pictograms. Controlling an amount of time on the Internet.

Still another feature of the present invention is to provide a computer program product for implementing supervision functions for Internet browsing. The computer program product including a plurality of computer executable instructions stored on a computer readable medium. Wherein, the instructions when executed by a computer having a graphical user interface cause the computer to perform the steps of initiating a custom browser on the computer. The custom browser communicates with a centralized database of authorized content. The authorized content has one or more pictograms associated to the authorized content. The one or more pictograms are displayed on the graphical user interface of the computer. Authorized content is downloaded from the Internet onto the graphical user interface of the computer in response to the activation of the one or more pictograms.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1 is a flow diagram of a Logical model of the KidSafe Application Architecture;

FIG. 2 is an illustration of an example of pictograms displayed on a graphical user interface according to one embodiment of the present invention;

FIG. 3 is a flow diagram of the process of content filtering mechanism; and

FIG. 4 is an illustration of an example of the warning provided if the child tries to leave the safe web island according to one embodiment of the present invention.

Similar reference characters refer to similar parts throughout the several views of the drawings.

### DETAILED DESCRIPTION OF THE INVENTION

In the following description, the system is described in connection with a computer (KidSafe Portal Client) that manages content to be accessed by children on a network and with another computer (KidSafe Portal Server) or more that are used to host a database of authorized web sites, statistics, news and a product catalogue (of purchasable themes and safe web islands) and with the assumption of having Internet connection (TCP/IP-based using HTTP\HTTPS protocol) available between these computers.

Computing facility for KidSafe Portal Client may comprise a commercial, off-the shelf computing facility, such as and without limitation a personal computer and the like. The computing facility may run a Microsoft Windows-brand or Mac operating system.

Computing facility for KidSafe Port Server may also comprise a commercial, off-the shelf computing facility, such as and without limitation a computer server with Intel-base CPU and the like and it may run a Microsoft Windows-brand server operating system (Windows Server 2003, 2008 or similar).

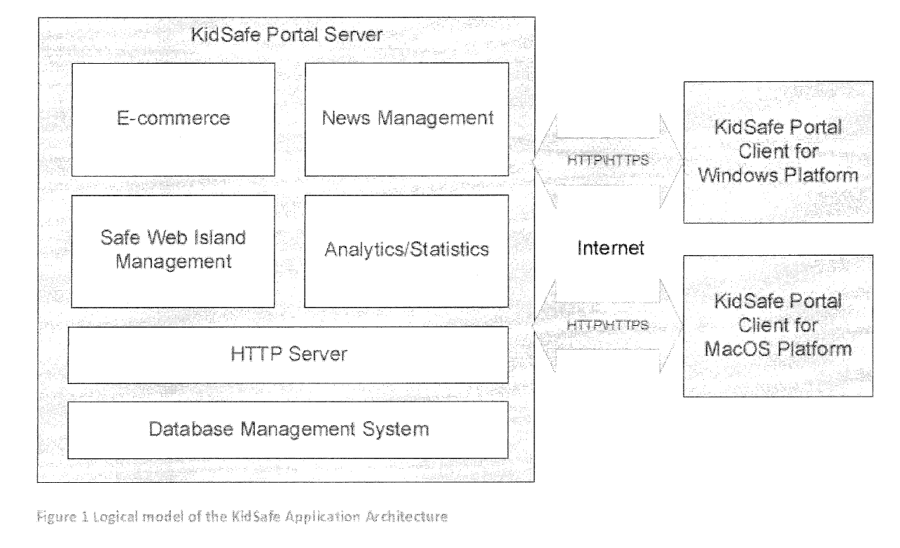

FIG. 1 shows a diagram of how the functionality of the system can be split between the KidSafe Portal Server and Client and what functional modules are implemented (software infrastructure) and installed on the computers facilities described above. As shown in FIG. 1, KidSafe Portal Client is implemented as a custom browser to provide the interface between the user and the Internet. The browser controls all requests and replies so that the user has a layer of protection between himself and the Internet.

KidSafe Portal Server acts as a management server that can be accessed by the computing device with KidSafe Portal Client installed over a network. The computing device with KidSafe Portal Client may establish a session to KidSafe Portal Server and then interact with it in order to at least:

1) Downloading Safe Web Island database every time when the KidSafe Portal client starts;

2) Enabling the KidSafe Portal Client to download a new theme from Server;

3) Pulling news content specific to an installed theme; and

4) Collecting anonymous and aggregated statistics on browsing activities

The client interface is implemented in a way that is easily usable by the children while providing a rich but safe network browsing environment. In addition, the interface includes an easily understandable starting screen that lists the pictograms of safe web sites that are authorized to be visited by the child without knowing their URL.

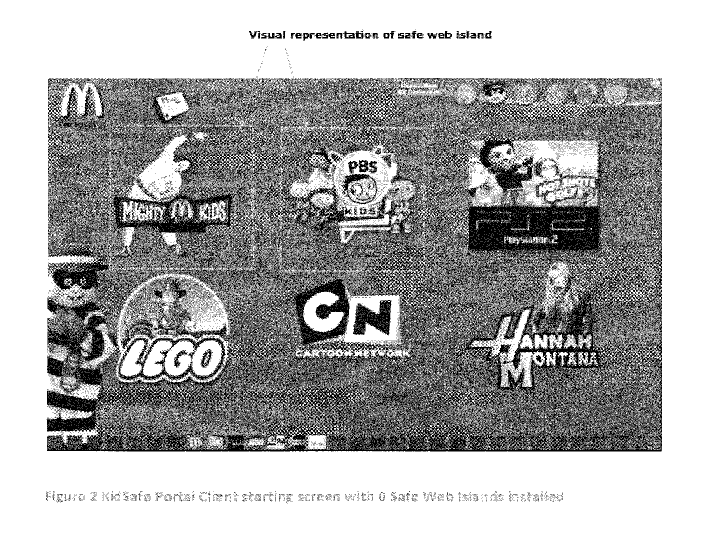

Each pictogram in FIG. 2 represents a Safe Web Island. FIG. 2 shows KidSafe Portal Client starting screen with six Safe Web Islands installed. Furthermore, the KidSafe Portal client can be themed dynamically that allows presenting an animated starting screen and similarly styled buttons and other user interface elements that reflect the same installed theme. Parents can purchase and download new themes at the KidSafe Portal Server and install it on their local instance of the KidSafe Portal Client application.

If one of the Safe Web Islands is selected then the Client application switches to browsing view and it starts measuring time of surfing on the Internet. The child may start viewing all pages and embedded multimedia assets that are part of the Safe Web Island. The KidSafe Portal system operates to limit the content to which a child has access to approved content. That is, content that has already been reviewed and deemed safe by system administrators, by a configuration management system installed at KidSafe Portal Server.

The system maintains a database of approved content that can include web pages, web sites, video, audio, photographs, graphic images, and other retrievable content. Thus, the system assumes a database of approved content that may be added to over time as new web pages, sites, and media content are created.

The KidSafe Portal Client uses a custom browser to provide the interface between the user and the Internet. The browser controls all requests and replies so that the user has a layer of protection between himself and the Internet. KidSafe Portal Client can be downloaded from KidSafe Portal Server via the Internet or it can be provided on a CD or DVD disc.

Once the KidSafe Portal Client is installed and after verifying the availability of Internet connection it will check any updated description of the Web Safe Island database and if there is newer version of the database then it will download it immediately and automatically as a background process.

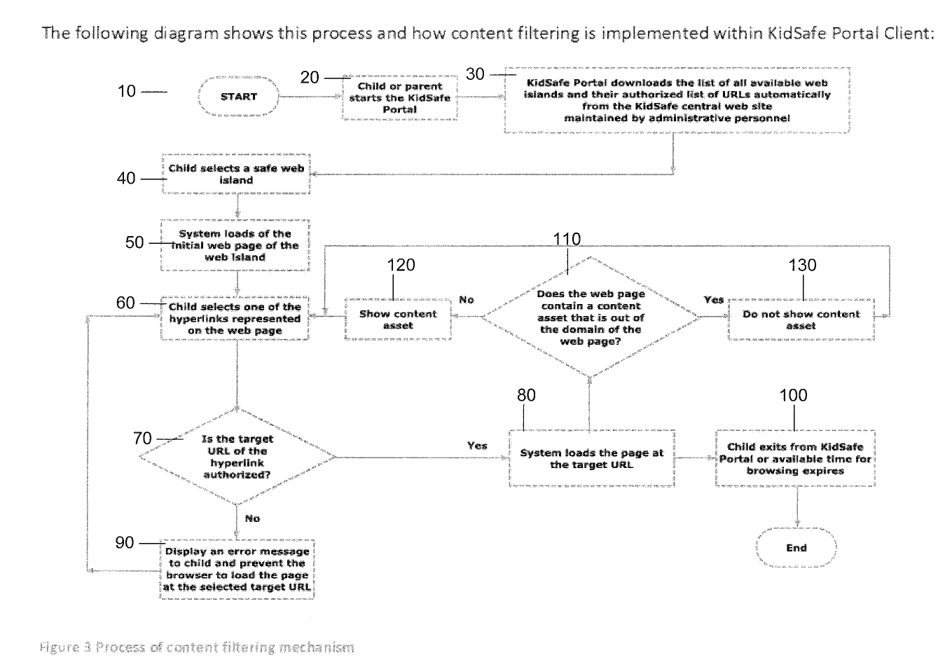

The flow diagram of FIG. 3 shows this process and how content filtering is implemented within KidSafe Portal Client. Initially, the custom browser application (KidSafe Portal) 20 is launched by the parent or child. The custom browser connects to a centralized server (KidSafe central website) 30 via the internet to download a list of available web islands as pictograms and their authorized list of URLs that are maintained by administrative personnel. Then, the child selects a safe web island 40 by activating the pictogram on a graphical user interface. The system loads the initial web page of the selected web island 50. The child selects one of the hyperlinks represented on the web page 60. The target URL of the hyperlink is compared to the authorized database on the centralized server 70. If the target URL is authorized, then the system loads the page from the target URL 80. If the target URL is not authorized, then an error message will be displayed and the custom browser will not load the target URL 90. After reviewing the authorized target URL, the child can exit from KidSafe or the available time for browsing can expire 100.

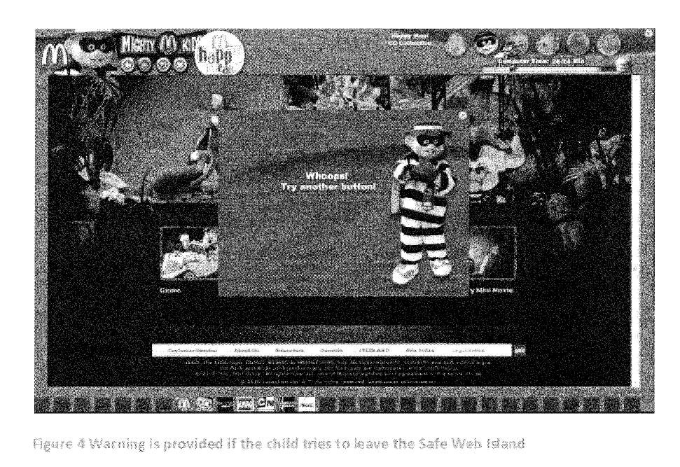

In addition, a filter 110 checks to see if the web page contains content that is out of the domain of the web page. If no, then the filter allows for the content to be shown 120. If yes, then the filter does not allow for the content to be shown 130. The illustration of FIG. 4 shows an example of the warning that a child will get if the content within the Web Safe Island points or references outside of the Web Safe Island content domain.

The built-in time control functionality in KidSafe Portal Client allows the parents to limit and control the time their child spends on computer, access the Internet and play games. Time control accumulates time per day that was used by the child on browsing the Internet independently from the event from exiting and restarting the KidSafe Portal Client application. If the authorized duration measured in a single day is exceeded then the application restricts the child to open any further web pages till the next day.

Initially, a database of approved content assets is assembled in what is called a Safe Web Island. This database is stored at KidSafe Portal Server and it is defined by a review of individual media items (content asset), i.e. review of a web page, a video, a photo, or any other individual media item or reviewing a web domain, evaluating all the pages belonging to a domain, such as www.mcdonalds.com and determining whether every page in the domain should be approved or rejected.

Once Safe Web Islands are created and published to KidSafe Portal Server then it will be downloaded by the KidSafe Portal clients to use as the basis of the content filtering. If Safe Web Island or a Theme prepared by KidSafe administrative personnel is published to KidSafe Portal Server then it can be purchased and downloaded by parents and installed on individual KidSafe Portal Clients in a simple and straightforward installation process. KidSafe Portal server provides a simple e-commerce function to enable parents to purchase themes and safe web islands using their credit card.

Both KidSafe Portal Client and Server are prepared to send and receive statistics information about their operations. This statistical information is prepared for each theme and platform. Currently the following metrics are provided: installs per month; installs per day; total installs; usage per day; usage per logon; usage per month; and domains usage. These statistics are aggregated across all users and they cannot provide information on individual user activities.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed:

1. A computer implemented method for safely navigating the Internet comprising the steps of:
storing authorized content in an access authorization database on a centralized server;
generating one or more pictograms of said authorized content on said centralized server;
initiating a custom browser on a computer having a graphical user interface, said custom browser communicating over the Internet with said access authorization database on said centralized server;
displaying said one or more pictograms onto said graphical user interface;
activating said one or more pictograms; and
downloading said authorized content from the Internet onto said graphical user interface in response to said activation of said one or more pictograms.

2. The method according to claim 1, wherein said authorized content further comprising web pages, web sites, video, audio, photographs and graphic images.

3. The method according to claim 1, further comprising controlling said authorized content through a configuration management system.

4. The method according to claim 1, further comprising linking said one or more pictograms to a merchant.

5. The method according to claim 1, further comprising displaying a graphical theme on said graphical user interface.

6. The method according to claim 5, further comprising downloading news content from the Internet that is specific to said graphical theme.

7. The method according to claim 1, further comprising controlling an amount of time on the Internet.

8. The method according to claim 1, further comprising collecting anonymous and aggregated statistics on browsing activity.

9. A computer implemented method for safely navigating the Internet comprising the steps of:
storing authorized content in an access authorization database on a centralized server;
generating one or more pictograms of said authorized content on said centralized server;
initiating a custom browser on a computer having a graphical user interface, said custom browser communicating over the Internet with said access authorization database on said centralized server;
displaying said one or more pictograms onto said graphical user interface;
activating said one or more pictograms;
downloading said authorized content from the Internet onto said graphical user interface in response to said activation of said one or more pictograms; and
controlling an amount of time on the Internet.

10. The method according to claim 9, wherein said authorized content further comprising web pages, web sites, video, audio, photographs and graphic images.

11. The method according to claim 1, further comprising controlling said authorized content through a configuration management system.

12. The method according to claim 9, further comprising linking said one or more pictograms to a merchant.

13. The method according to claim 12, further comprising displaying a graphical theme on said graphical user interface.

14. The method according to claim 13, further comprising downloading news content from the Internet that is specific to said graphical theme.

15. The method according to claim 9, further comprising collecting anonymous and aggregated statistics on browsing activity.

16. A computer program product for implementing supervision functions for Internet browsing, said computer program product including a plurality of computer executable instructions stored on a computer readable medium, wherein said instructions, when executed by a computer having a graphical user interface, cause the computer to perform the steps of:
initiating a custom browser on the computer, said custom browser communicating with a centralized database of authorized content, said authorized content having one or more pictograms associated to said authorized content;
displaying said one or more pictograms on said graphical user interface; and
downloading said authorized content from the Internet onto said graphical user interface when said one or more pictograms are activated.

17. The computer program product according to claim 16, further comprising a configuration management system.

18. The computer program product according to claim 16, further comprising displaying a graphical theme on said graphical user interface.

19. The computer program product according to claim 18, further comprising downloading news content from the Internet that is specific to said graphical theme.

20. The computer program product according to claim 16, further comprising activating a timer, said timer controlling the amount of time on the Internet.

21. The computer program product according to claim 16, further comprising collecting anonymous and aggregated statistics on browsing activity.
